(19) United States
(12) Patent Application Publication
(10) Pub. No.: US 2026/0090564 A1
(43) Pub. Date: Apr. 2, 2026

(54) MOCHIS WITH FUNCTIONAL INGREDIENTS AND MANUFACTURING METHOD

(71) Applicant: NUTRIS INGREDIENTS, S.L., Madrid (ES)

(72) Inventor: Pedro De la Fuente Blasco, Madrid (ES)

(73) Assignee: NUTRIS INGREDIENTS, S.L., Madrid (ES)

(21) Appl. No.: 18/911,343

(22) Filed: Oct. 10, 2024

(30) Foreign Application Priority Data
Sep. 30, 2024 (ES) 202430781

(51) Int. Cl. A23G 3/36; A23G 3/34; A23G 3/42; A23G 3/44; A23G 3/48

(52) U.S. Cl. CPC A23G 3/368; A23G 3/0027; A23G 3/42; A23G 3/44; A23G 3/48

(57) ABSTRACT

The invention relates to mochi with functional food or pharmaceutical ingredients that comprises: Glutinous rice, trehalose, water, gelatin and/or pectin and/or agar and/or carrageenan and/or collagen and/or other gelling agents, aromas, flavors and other excipients which interfere with the organoleptic properties of the mochi, as well as with the pH, functional ingredients, pH regulators; where it can also have glucose syrup and sugar, or fiber, or protein or polyols, where the functional ingredients can be microencapsulated and the functional ingredients can be with amino acids or omega 3, omega 9, or melatonin to make it easier to fall asleep, ibuprofen or paracetamol, etc.

### OBJECT OF THE INVENTION

The object of the present invention, as the title of the invention states, is a mochi with functional ingredients, where mochis are Japanese sweets cooked with glutinous rice and other ingredients and where said mochis comprise functional ingredients, including food ingredients: Plant extracts, powdered, liquid or semi-solid plants, amino acids, proteins (collagen among others), vitamins, minerals, oils, fibers, live or tyndallized probiotic microorganisms and/or active pharmaceutical ingredients such as analgesic, anti-inflammatory, antiviral, anti-infective, antifungal, antipyretic ingredients and/or stem cells or derivatives. These ingredients could be microencapsulated ingredients with the aim of providing functional mochi with the property of releasing the active ingredients in a controlled manner.

The present invention is characterized by the particular specifications of mochi, since the composition is predominantly based on glutinous rice, trehalose, sugar, glucose syrup or sugar substitutes such as fructoligosaccharides, polyols, proteins or fruit preparations, among other sources, that achieve suitable gelation and stability for the consumption thereof and the steps of the method and particularly the dilution of the functional ingredients in a medium, with suitable additional additives added at a suitable time and temperature in order to enable the final state and flavor of the mochi, such that the ingredients do not degrade and the characteristic organoleptic properties of the mochi are maintained.

Therefore, the present invention falls within the scope of a new mochi and the manufacture of mochi-type sweets, as well as within a new food matrix with applications for health, as well as a new pharmaceutical form with application in the food, pharmaceutical, and medical field and in general in the food and health sectors.

### BACKGROUND OF THE INVENTION

Mochis are Japanese sweets with a soft but consistent, elastic and/or creamy texture, made mainly from glutinous rice and to which fruits, ice cream, chocolate, and mostly nuts are added. They are currently used as a food source, especially as a sweet, without the aim of providing nutritional and/or healthy and/or pharmaceutical values. In the specific case of this invention, in addition to the usual ingredients for making mochis, gelatins, pectins, starches, agar-agar, carrageenan, collagen and other ingredients with gelling capacity are added, to which sweeteners, flavorings and food dyes are added, in order to achieve a texture, organoleptic properties and adequate stability to be able to add the functional ingredients that will provide the mochis with healthy properties. They have a finish so that they do not stick together, consisting of a coating based on starch and powdered sugar, although for certain preparations vegetable oils, polyols, acids, some amino acids such as glycine or ingredients with nutritional or pharmaceutical activity such as probiotics can be added to the coating. They have an infinite number of shapes: bears or other animals, coca cola bottles, rings, different fruits, etc., although the most common shape is semicircular or oval and usually irregular.

Mochis can be considered as a pharmaceutical form. So far no mochis with functional ingredients responsible for healthy activity are known, since the incorporation of the functional active ingredients described above (including ingredients considered as pharmaceutical) involves a modification of the usual base that makes up these products, in addition to the solubility and homogenization behavior of the liquid or semi-solid dough of the first steps of manufacturing the mochis, as well as a variation in the key parameters (pH, dry residue, degrees Brix, solubility, temperature and moisture, among others) that influence the gelation and/or solidification process of this new pharmaceutical form.

The following patents that disclose methods and formulations for preparing mochis are known in the state of the art:
WO2012173004
JP2024079144 A
CN107136417 A
CN108936301 A

However, none of these patents have functional food ingredients integrated under certain conditions and offering additional functionalities.

Therefore, the object of the present invention is to protect a mochi with functional ingredients and the manufacturing process of mochis with healthy functional ingredients, either food or pharmaceutical, maintaining the appearance, organoleptic properties and typical features of mochis, developing a process such as the one described below and which is summarized in its essential nature in the first claim.

### DESCRIPTION OF THE INVENTION

The object of the present invention is a mochi with either functional food or pharmaceutical ingredients (as described in the Object of the Invention), having a base with sugar or without added sugar or sugar-free and which is carried out by a manufacturing process comprising the steps of:
On the one hand, firstly, the dough that will make up the mochi is made by mixing glutinous rice, trehalose, sweeteners/carbohydrates (sugar and/or glucose syrup and/or plant, animal, synthetic or fermentation fibers and/or polyols, water and gelling agent (gelatin or pectin or agar-agar or starch or collagen or carrageenan or other gelling agents). The carbohydrate sources can be sugars, fibers such as polydextrose and other plant fibers such as fructoligosaccharides. These ingredients could be organic and the product could be therefore claimed as such. The exact amounts of each ingredient are not always the same, but rather certain proportions, within ranges that will be detailed below, which will finally give it a texture, consistency and organoleptic properties specific to the mochi depending on its functional purpose. This initial dough is called “Base dough”.
On the other hand, in a complementary manner and additionally, a mixture is prepared with the aromas, flavors and other excipients which interfere with the organoleptic properties of the mochi, as well as with the pH, which should be essential at the beginning of the mixture so that the mochi finally gels and remains consistent. This mixture is called “Organoleptic dough”.
Next, an independent mixture is prepared which will consist of mixing one or more active ingredients, either food or pharmaceutical. This mixture will be called “functional independent mixture” during the drafting of this patent. This preparation or “functional independent mixture” will be made by homogenizing the ingredients to allow their incorporation into the final mixture that is described below, in a stable manner that guarantees the non-degradation thereof. For this purpose, it is possible to use a mixer consisting of two tanks with stirrers and jackets that allow temperature control, said tanks connected by two pipes that allow the preparation to recirculate and consequently perfectly homogenize the mixture.
In this invention the amount of active ingredients is very relevant, since it is the main difference and the epicenter of this invention. The active ingredients can vary from 0.1% to 75% of the total formulation depending on the functional property of the mochi. For example, if we intend to make a mochi rich in fiber or protein, the amount of fiber or protein (active ingredient) could reach up to 75% (not considering water) and if it is a mochi to promote falling asleep with melatonin (active ingredient), the amount of active ingredient could not exceed 0.1% of the dry weight.
Next, these masses are mixed into a single dough called “Final mixture” in a large capacity mixing tank with stirring and temperature control
Depositing this mixture on trays with a starch base or on metal, plastic or silicone trays, whereon the molds of the mochis have been previously placed through a machine called a Mogul or an equivalent machine. The molds are the shapes, in other words, bear, fruits, etc. These molds are filled with the dough
Drying the filled molds in rooms where the moisture and temperature are controlled or using a drying tunnel until the mochis acquire the adequate consistency so that they can be de molded.
Unmolding the mochis.
Packaging the mochis once they have been unmolded.

For this manufacturing process, a production line called Mogul or an equivalent machine is used, which is commonly used to make gummies, and there is no documentation certifying that it has been previously used for the production of mochis, meaning that manufacturing mochis in Mogul is an innovation. For this reason, all the steps described above could be considered to be novel. This fact becomes more relevant when it comes to manufacturing mochis, with the incorporation of functional ingredients responsible for healthy activity, such helping to reduce cholesterol or increase the levels of omega 3 and omega 9, improve vitamin and mineral intake within a healthy diet, etc., since it requires preparing the functional independent dough and adding it to the “final dough” before gelation and below a certain temperature.

The functional ingredients that we use to incorporate into the mixtures are common ingredients, but these ingredients must meet specific pharmacotechnical characteristics and, most cases, have not been previously incorporated into a mochi, for which reason the final mochi product with functional ingredients is novel. The functional ingredients may include a microencapsulation resistant to the mochi production process, with the aim of providing not only healthy activity, but also the possibility of releasing the active ingredients in a controlled manner over time. An example of this application is melatonin. If we add a microencapsulated melatonin to the mochis that allows for the sustained release thereof, for example, for 6 hours, it will make it possible to sleep for more hours than regular melatonin (which acts during the first three hours of sleep) and will provide additional value to the invention. This possibility is part of this invention, since it involves technology compatible with the manufacture of mochis.

Unless otherwise stated, all technical and scientific elements used in this specification have the meaning commonly understood by a person with ordinary skill in the art to which this invention belongs. In the practice of the present invention, similar or equivalent methods and materials to those described in the specification can be used.

Throughout the description and the claims, the word “included” and its variants do not intend to exclude other technical features, additives, components or steps. For those skilled in the art, other objects, advantages and features of the invention may be partially deduced from both the description and the embodiment of the invention.

### PREFERRED EMBODIMENT OF THE INVENTION

A possible embodiment of the mochis object of the invention is carried out by means of a method comprising the steps of:
Firstly, the “base dough” of the mochi is made with a mixture of glutinous rice, trehalose, sweeteners such as fibers, sugars, glucose syrup and/or polyols, water, and gelling agents such as gelatin and/or pectin and/or agar and other gelling agents. This mixture is made at a temperature between 75° C. and 125° C. This cooking of the mixture must be done in a homogeneous manner, avoiding exceeding the temperature of 125° C., since otherwise burnt particles may appear that are not suitable for consumption. Next, vacuum cooling is carried out at a pressure of 0.1-0.5 bar to a temperature of 70-105° C. The base dough, once it has cooled, must be kept stirring at a maximum speed of 70 rpm.
Additionally, a mixture is prepared with the aromas, flavors and other excipients which interfere with the organoleptic properties of the mochi, as well as with the pH, which is less than 8 and greater than 4 at the beginning of the process to prevent the final dough from gelling prematurely and to maintain the appropriate density (0.5-1.9 g/ml). This dough is called “organoleptic dough”.
Next, the “Functional independent mixture” is prepared by diluting functional ingredients in a liquid medium, preferably, but not limited to, water, where it could also be oil or the “base dough” itself. To prepare the functional independent mixture, two tanks connected by separate pipes will be used that allow the dilution to be recirculated and thus guarantee the correct homogenization of the functional independent mixture. Each tank will have an independent stirrer and temperature control. Stirring conditions should not exceed 79 rpm and the individual temperature of the tanks should not exceed 80° C.
Once the dough is made: Base dough, Organoleptic base and the functional independent mixture. All of them are mixed in a large capacity tank, also known as basins, with independent stirring and temperature control by means of hydraulic jackets or similar systems. This final mixture is called “Final dough”.
Adding citric acid and pH regulators to the previous dilution, in an amount that does not exceed 0.2% in order to reduce the pH of the mixture and promote the gelling of the mochi during the cooling and drying process.
It is critical that the “functional independent mixture” to form the final dough is incorporated when the temperature of the base dough and the organoleptic dough is less than 80° C.
Depositing this mixture (final dough) on trays made of wood, fiber or similar materials with a starch base, whereon the mochi molds have previously been marked with primer. The trays could also be made of metal, but in this case they will not be filled with starch, but rather the molds on which the “final dough” will be injected will be fixed. In other words, the trays are already manufactured with the specific molds. This process of injecting the final dough into the molds printed on the starch of the wooden or fiber trays or on the metal trays is done through a machine commonly called “Mogul”. This process is also known as deposit manufacturing, since it indicates how the final dough should be deposited by injection into starch or metal molds. The molds are the final shapes of the mochis, in other words, bear, fruits, etc.
Once the deposit process is complete, the Mogul trays are collected and placed in drying rooms where they must remain for 5-72 hours, depending on the formula prepared, at a maximum temperature of 65° C. and a humidity below 90%. This process is called “Drying”.
In the case of using metal trays for depositing the mochis, the drying process could be done using a cold tunnel. By subjecting the mochis to passage through a tunnel for a time between 3 and 60 minutes at a temperature below 25° C. and a humidity below 75%.
Unmolding the mochis: Once the mochis are deposited on the trays and subjected to the drying process, they are then unmolded. To unmold them, the dry matter must reach a minimum of 75%. The mochis are unmolded by tipping the trays over and letting them fall by gravity. These mochis, already unmolded, will go to a coating drum where they will be given a bath or coating in oil, sugar, acids, proteins, probiotics and/or other functional food and/or pharmaceutical or technological ingredients with three main objectives:
1.—Prevent the mochis from sticking together.
2.—Promote the organoleptic properties.
3.—Provide functional or nutritional value.

The weight of the coating should not exceed 50% of the total weight of the mochi.

The mochis with functional ingredients comprise:
Glutinous rice, trehalose, water, gelatin-based gelling agents, and/or agar and/or pectin and/or carrageenan and/or collagen and/or other gelling agents.
aromas, flavors and other excipients which interfere with the organoleptic properties of the mochi, as well as with the pH which can be any one or a combination of acid, powdered sugar and starch.
functional ingredients
pH regulators

Additionally, there may be one of the following alternatives:
a) In case of mochis with sugar, they would additionally have glucose syrup and sugar.
b) In the case of sugar-free mochis, they would additionally have polyols
c) In the case of mochis with fiber, they would additionally have fibers such as polydextrose and/or fructoligosaccharides and/or other plant fibers.
d) In the case of mochis with protein, they would have proteins.

The percent composition for mochis with sugar is:
Glutinous rice: 10-20%
Gelling agent: 1-3%
Glucose Syrup: 30-45%
Sugar: 20-40%
Trehalose: 1-8%
Aromas and dyes: 1-5%
Acids: 0.1-2%
Functional ingredients: 0.1-20%
Water at least 25%, a sufficient quantity to complete the dissolution and homogenization of the ingredients.

The percent composition for sugar-free mochis with polyols is:
Glutinous rice: 10-20%
Gelling agent: 1-3%
Polyols: 20-85%
Trehalose: 1-8%
Aromas and dyes: 1-5%
Acids: 0.1-2%
Functional ingredients: 0.1-20%
Water at least 25%, a sufficient quantity to complete the dissolution and homogenization of the ingredients.

The percent composition of mochis with fiber is:
Glutinous rice: 10-20%
Gelling agent: 1-3%
Fibers: 20-85%
Trehalose: 1-8%
Aromas and dyes: 1-5%
Acids: 0.1-2%
Functional ingredients: 0.1-20%
Water at least 25%, a sufficient quantity to complete the dissolution and homogenization of the ingredients.

The percent composition of mochis with protein is:
Glutinous rice: 10-20%
Gelling agent: 1-3%
Polyols: 20-85%
Proteins: 20%-75%
Trehalose: 1-8%
Aromas and dyes: 1-5%
Acids: 0.1-2%
Functional ingredients: 0.1-20%
Water at least 25%, a sufficient quantity to complete the dissolution and homogenization of the ingredients.

Among the embodiments that can be achieved are: a sugar-free mochi with amino acids (tryptophan, glycine, etc.) suitable for diabetics and which helps combat anxiety during periods of dieting. Mochis, for example, to help reduce cholesterol or increase levels of omega 3 and omega 9, improve vitamin and mineral intake within a healthy diet, mochis with melatonin to make it easier to fall asleep. mochis with ibuprofen with an analgesic effect, mochis with paracetamol, etc.

Having sufficiently described the nature of the present invention, as well as the manner in which it may be put into practice, it is noted that, within the essential nature thereof, the invention may be put into practice in other embodiments that differ in detail from that which is indicated by way of example, and for which the protection sought will also be achieved, as long as it does not alter, change or modify the fundamental principle of the invention.

1-12. (canceled)

13. A mochi with functional food or pharmaceutical ingredients, comprising
(i) glutinous rice, trehalose, water, gelling agents based on gelatin and/or pectin and/or agar and/or carrageenan and/or collagen and/or other gelling agents,
(ii) aromas, flavors and other excipients which interfere with the organoleptic properties of the mochi, as well as with the pH, which can be any one or a combination of acid, powdered sugar and starch,
(iii) functional ingredients, and
(iv) pH regulators.

14. The mochi with functional food or pharmaceutical ingredients of claim 13, additionally comprising contains sugars and/or glucose syrup.

15. The mochi with functional food or pharmaceutical ingredients of claim 14, consisting of the following ingredients by weight-percent:
glutinous rice: 10-20%
gelling agent: 1-3%
glucose syrup: 30-45%
sugar: 20-40%
trehalose: 1-8%
aromas and dyes: 1-5%
acids: 0.1-2%
functional ingredients: 0.1-20%, and
water at least 25%, sufficient to complete the dissolution and homogenization of the ingredients.

16. The mochi with functional food or pharmaceutical ingredients of claim 13, further comprising polyols.

17. The mochi with functional food or pharmaceutical ingredients of claim 16, consisting of the following ingredients by weight-percent:
glutinous rice: 10-20%
gelling agent: 1-3%
polyols: 20-85%
trehalose: 1-8%
aromas and dyes: 1-5%
acids: 0.1-2%
functional ingredients: 0.1-20% and
water at least 25%, in sufficient quantity to complete the dissolution and homogenization of the ingredients.

18. The mochi with functional food or pharmaceutical ingredients of claim 13, further comprising fiber.

19. The mochi with functional food or pharmaceutical ingredients of claim 18, consisting of the following ingredients by weight-percent:
glutinous rice: 10-20%
gelling agent: 1-3%
fibers: 20-85%
trehalose: 1-8%
aromas and dyes: 1-5%
acids: 0.1-2%
functional ingredients: 0.1-20% and
water at least 25%, in sufficient quantity to complete the dissolution and homogenization of the ingredients.

20. The mochi with functional food or pharmaceutical ingredients of claim 13, further comprising proteins.

21. The mochi with functional food or pharmaceutical ingredients of claim 20, consisting of the following ingredients by weight-percent:
glutinous rice: 10-20%
gelling agent: 1-3%
polyols: 20-85%
proteins: 20%-75%
trehalose: 1-8%
aromas and dyes: 1-5%
acids: 0.1-2%
functional ingredients: 0.1-20% and
water at least 25%, in sufficient quantity to complete the dissolution and homogenization of the ingredients.

22. The mochi with functional food or pharmaceutical ingredients of claim 13 wherein said functional ingredients are microencapsulated.

23. A manufacturing method for the mochis with functional ingredients comprising performing the following steps in order:
(i) firstly, the “base dough” of the mochi is made at a temperature between 75° C. and 125° C., in a homogeneous manner, avoiding exceeding the temperature of 125° C.;
(ii) next, vacuum cooling is carried out at a pressure of 0.1-0.5 bar to a temperature of 70-105° C., where the base dough, once it has cooled, must be kept stirring at a maximum speed of 70 rpm;
(iii) additionally, a mixture is prepared with the aromas, flavors and other excipients which interfere with the organoleptic properties of the mochi, as well as with the pH, which is less than 8 and greater than 4 at the beginning of the process to prevent the final dough from gelling prematurely and to maintain the appropriate density (0.5-1.9 g/ml), where this dough is called “organoleptic dough”;
(iv) next, the “functional independent mixture” is prepared, by diluting functional ingredients in a liquid medium, to prepare the functional independent mixture, two tanks connected by separate pipes will be used that allow the dilution to be recirculated and thus guarantee the correct homogenization of the functional independent mixture;
(v) once the dough is made, the base dough, organoleptic base and the functional independent mixture are all mixed together in a large capacity tank, also known as basins, with independent stirring and temperature control by means of hydraulic jackets or similar systems, wherein this final mixture is called “final dough”, where the functional independent mixture is incorporated into the final mixture when the temperature of the base dough and organoleptic base is less than 80° C.;
(vi) next, citric acid and pH regulators are added to the previous dilution, in an amount that does not exceed 0.2% in order to reduce the pH of the mixture and promote the gelling of the mochi during the cooling and drying process;
(vii) the process continues with the deposit of this “final dough” on trays made of wood, fiber or similar materials with a starch base, whereon the mochi molds have previously been marked with primer, this process of injecting the final dough into the molds printed on the starch of the wooden or fiber trays or on the metal trays is done through a machine commonly called “mogul”;
(viii) mogul trays are collected and placed in drying rooms where they must remain for 5-72 hours, depending on the formula prepared, at a maximum temperature of 65° C. and a humidity below 90%. this process is called “drying”;
(ix) the mochis are unmolded once they have been deposited on the trays and subjected to the drying process, wherein the dry matter comprises at least a 75% by weight.

24. The manufacturing method for the mochis with functional ingredients of claim 23, wherein each of the tanks used in the preparation of functional independent mixture has an independent stirrer and temperature control, where the stirring conditions do not exceed 79 rpm and the individual temperature of the tanks does not exceed 80° C.
